(19) United States
(12) Patent Application Publication
(10) Pub. No.: US 2023/0072021 A1
(43) Pub. Date: Mar. 9, 2023

(54) TREATMENT OF WASTEWATER

(71) Applicant: Steven L. Cort, Cary, NC (US)

(72) Inventor: Steven L. Cort, Cary, NC (US)

(21) Appl. No.: 17/929,848

(22) Filed: Sep. 6, 2022

Related U.S. Application Data
(60) Provisional application No. 63/360,092, filed on Sep. 7, 2021.

(51) Int. Cl. C02F 9/00; C02F 1/52; C02F 1/56; C02F 1/28; C02F 11/10; C02F 11/14; C02F 11/18; C02F 1/02; C02F 11/02; C02F 3/34

(52) U.S. Cl. CPC C02F 9/00; C02F 1/5227; C02F 1/56; C02F 1/283; C02F 11/10; C02F 11/14; C02F 11/18; C02F 1/025; C02F 11/02; C02F 3/348; C02F 3/343; C02F 2101/30

(57) ABSTRACT

The present Invention relates to a new and novel process for treatment of wastewater that combines treatment methods that use Ballast Material (BM), Hydrothermal Carbonization (HTC), Hydrodynamic Cavitation (HDC), Probiotics (PB), acid, and Bio-Adsorbents (BA) to replace biological treatment of wastewater, specifically Activated Sludge Technology (AST).

### CROSS-REFERENCE TO RELATED APPLICATION

This application claims priority from Provisional Application Ser. No. 63/360,092, filed Sep. 7, 2021.

### FIELD OF THE INVENTION

The present invention relates to a process for treating wastewater that combines clarification to remove solid organics from wastewater followed by adsorption of dissolved organic pollutants using carbon-based adsorbents that have been processed by Hydrodynamic Cavitation (HDC) and Hydrothermal Carbonization (HTC) to produce Hydrochar (HC) or Ballasted Hydrochar (BHC). Solid organic wastes are also processed by HDC and HTC to produce nutrients for growing Probiotics (PB) that can also be colonized onto HC or BHC to produce bio-adsorbents (BA) also used to treat dissolved pollutants in wastewater. The process can be retrofitted into an existing wastewater treatment plant (WWTP) to replace biological treatment (i.e. Activated Sludge Technology—AST) or to replace Chemical Enhanced Primary Treatment (CEPT), or can be employed in a new plant, especially useful in lesser-developed countries.

### BACKGROUND OF THE INVENTION

Contaminants in wastewater are either solid or dissolved. The predominant methods for removing pollutants associated with Total Suspended Solids (TSS) from water are either filtration or clarification. Filtration is a mechanical process that includes technologies such as bag filters, sand filters, and membranes. Clarification is a field-separation process that either uses gravity that may be enhanced with the use of ballast materials to settle TSS rapidly, or by flotation such as Dissolved Air Flotation (DAF) that uses the buoyancy of air bubbles to float TSS.

For clarity, the following abbreviations are defined:

AST—Activated Sludge Technology is a combination of clarification, biological treatment, and disinfection. This is the predominant prior art method of water treatment in developed countries.

BA—Bio-adsorbent is a carbon adsorbent that has been colonized by Probiotics (PB).

BEPT—Biologically Enhanced Primary Treatment is a process that uses the adsorption capacity of Mixed Liquor Suspended Solids (MLSS) in a solids contact tank followed by high rate clarification.

BHC—Ballasted Hydrochar is the combination of BM and Hydrochar or other carbon adsorbents.

BM—Ballast Material is a solid weighting material with a specific gravity greater than 2.0 and is added to improve settling of solids contained in water by gravity. Examples include but are not limited to sand, fly ash, magnetite, and zero-valent iron.

CSO—Combined Sewer Overflow is a combination of sanitary sewage and storm water flowing in the same pipeline.

DAF—Dissolved Air Flotation is a technology that uses the buoyancy of air bubbles to float solids out of water.

FOG—fats, oil, or grease

HC—Hydrochar is a carbon adsorbent produced by HDC.

HDC—Hydrodynamic Cavitation is a process that uses the explosive force of collapsing bubbles to lyse and disinfect carbon cells.

HSS—Hydrodynamic Swirl Separator is a clarification device that causes water to flow in a swirling motion to aid in gravity clarification.

HTC—Hydrothermal Carbonization is a process that uses water under pressure and elevated temperature to carbonize wet carbon wastes into HC.

MBM—Modified Ballast Material is BM that has been modified to improve its adsorption properties and to improve its ability to treat wastewater without the need for chemical coagulants.

PB—Probiotics are beneficial bacteria that are efficient at treating water; these are preferably produced, according to this invention, from solid carbon wastes removed from wastewater.

SSO—Separate Sewer Overflow is sewage that overflows from a wastewater conveyance system.

TSS—Total Suspended Solids

WWTP—Wastewater Treatment Plant is a centralized facility designed to treat sanitary wastewater usually biologically.

One preferred approach to remove TSS from water is by the use of BM, defined as any solid material that has a specific gravity greater than 2.0 that aids in the settling of suspended solids by gravity in water. Flocculating polymer is used to attach TSS onto BM to form a weighted floc that settles more rapidly due to the weight of the BM. This weighted floc is then mechanically dispersed, separating the BM and TSS, so that the BM can be recovered and reused. TSS that is organic in nature is then converted into HC or BHC, which can then be used as an adsorbent to clean water or remove carbon dioxide from flue gas, or as an alternative fuel, chemical catalyst, or soil amendment to improve food production.

The specific gravity of BM is greater than 2.0 so it will settle rapidly by gravity. BM can be modified into MBM either mechanically or chemically so the MBM will act like a chemical coagulant. A preferred MBM is one that is amphoteric, so that its surface charge changes according to pH. At an alkaline pH (>7.0), the surface charge of such a MBM (e.g., magnetite) is negative, and at an acid pH (<7.0), the surface charge of such a MBM is positive. Thus, the surface charge of such a MBM neutralizes the surface charge of pollutants and therefore in most cases replaces the need for chemical coagulants. This is not the case with unmodified BM such as sand, which usually requires a positive-charged chemical coagulant to neutralize negative-charged particles often contained in wastewater.

The use of sand as a BM to speed particle settling was first patented by Desalle in 1998 (U.S. Pat. No. 5,730,864) and commercialized by Veolia as “Actiflo”. The major deficiency of the Actiflo design is the way the sand ballast is cleaned and reused. Sand-ballasted floc settles to the bottom of the Actiflo clarifier and is raked to the center of the clarifier so it can be pumped as a dilute slurry into a hydrocyclone where sand ballast is separated by centrifugal force and reused in the flocculation process. Actiflo consumes a large amount of energy for mixing and pumping, has high capital cost due to size and field erection requirements, experiences wear on critical pump parts due to abrasive sand, usually requires a chemical coagulant for charge neutralization, and produces a large quantity of dilute waste.

Retrofitting an existing gravity clarifier to employ MBM instead of sand eliminates the need for a chemical coagulant and will reduce the amount of waste generated.

The use of magnetite to clean drinking water was invented and first practiced over forty years ago in Australia with the development of the “Sirofloc” technology. Sirofloc does not use a flocculating polymer to attach particles to magnetite, but rather uses charge attraction to attach colloidal solids to magnetite of the opposite charge. Magnetite, after it adsorbs colloidal solids contained in water, settles out in a gravity clarifier. The magnetite is then removed by gravity, cleaned chemically, and reused in the clarification process. The Sirofloc process, while effective in removing colloidal particles and color from drinking water, produces chemical waste, cannot handle high concentrations of suspended solids often found in wastewater, and has higher chemical cost.

The “Comag” system, developed by Cambridge Water Technologies (CWT), improved the Sirofloc technology by using flocculating polymer and adding a final magnetic collector that produced a magnetic field using electromagnets to remove magnetic floc from wastewater. This modification made the clarification system smaller and in theory made it possible to treat water that contained higher levels of suspended solids, eliminated the use of magnetite-cleaning chemicals, reduced chemical costs, and initially eliminated the need for a gravity clarifier. However, the use of electromagnets in their magnetic collector posed some significant disadvantages. First, electromagnets are expensive and use more electricity than permanent magnets. Second, the magnetic collector contained stainless steel wool that is easily fouled and cannot process high levels of suspended solids. When the concentration of suspended solids was high, the Comag final magnetic collector quickly filled with suspended solids and had to be frequently backwashed with water and air. This frequent backwashing produced a large quantity of dilute waste. Third, the final magnetic collector had to be de-energized for cleaning, which interrupted the treatment process. Therefore, to correct these deficiencies, CWT abandoned the use of their magnetic collector and now instead only uses a gravity clarifier to remove flocculated solids. This present use of a gravity clarifier negates much of the initial size advantages of Comag. Siemens Water Technologies eventually purchased CWT and years later sold their water treatment business to Evoqua.

The present inventor's U.S. Pat. No. 7,255,793 overcame many of the disadvantages of the Comag and Actiflo systems by the introduction of Magnetic High-Rate Clarification (MHRC). The MHRC process is the only commercial clarification system using a magnetic collector, which can handle high levels of suspended solids, uses permanent magnets instead of electromagnets, is continuously cleaned and does not disrupt the treatment process, uses small amounts of electricity, and most importantly eliminates the need for a gravity clarifier. However, in retrofit applications where gravity clarifiers already exist, it is only necessary to add a supply of BM and a BM recovery and cleaning system to double or triple the treatment capacity of an existing WWTP without increasing its footprint.

CWT followed the development of Comag with “Biomag,” a system that uses magnetite to improve the settling characteristics of biosolids in a gravity clarifier to enhance AST systems. Biomag is described in Woodard U.S. Pat. No. 7,695,623. Woodard describes how magnetite can be imbedded into biofloc contained in an AST aeration basin to increase the biofloc's weight and therefore improve its settling rate in a secondary gravity clarifier. This improvement in floc settleability results in a two to three-fold increase in gravity clarifier capacity without increasing its footprint. However, this approach for increasing the settleability of biofloc by the addition of magnetite was not new and Woodard therefore only claims a collection of subsystems to enhance biological treatment performed in AST such as a weighting agent biofloc impregnation subsystem, a return activated sludge subsystem, a weighting agent recovery subsystem, and a sludge treatment subsystem all working together to improve the performance of AST. However, the system claimed by Woodard has several disadvantages that are overcome by the novel approach of this present invention.

First, Woodard describes a method to return biofloc weighted with magnetite (Returned Activated Sludge—RAS) to the aeration basin of an AST system. Adding magnetite to the aeration basin increases the weight of biofloc and therefore the amount of energy needed for pumping and keeping the weighted biofloc in suspension. Also, any magnetite that separates from biofloc can potentially settle to the bottom of the aeration basin causing major operating and cleanout problems.

Second, Woodard uses fine magnetite to help keep it in suspension and to imbed into the biofloc. In laboratory tests conducted by the present inventor, coarse magnetite (greater than 50 micron) will not effectively imbed into biofloc without the use of flocculating polymer and fine magnetite will not settle as well as coarse magnetite in a gravity clarifier. This shortcoming of the Woodard design is eliminated since in this present invention, BM is not added to the aeration basin but rather in-line and a coarser BM can therefore be used to enhance settling in the secondary gravity clarifier. The present invention also discloses replacement of the biological treatment portion of AST with BHC produced from sewage solids, which was not contemplated by Woodard.

Third, Woodard in FIG. 6 shows an “impregnation tank” that combines virgin magnetite, recycled magnetite, and biofloc, but the addition of flocculating polymer and coagulants to bind these solids together into a stable floc comes after the aeration tank and there is no in-line static mixer or mechanical mixer to enhance flocculation ahead of the secondary gravity clarifier. It is known in the art that effective in-line flocculation is best accomplished when flow-turbulence provides enough energy to create a stable quality floc, but not so high that flow-turbulence causes destruction of the floc. This is difficult to achieve when flow rates vary over a wide range as in the case with municipal treatment of sanitary wastewater at a WWTP. Furthermore, there is no easy way to control the energy needed for flocculation without the use of in-line mechanical or static mixers. It is known in the art that in-line flocculation is best accomplished by a controlled input of mixing energy; according to an aspect of this invention, energy is supplied by a static mixer and/or mechanical mixer, which are lacking in Woodard.

Fourth, Woodard shows only a one-stage system to recover magnetite for reuse. This produces a large volume of dilute wastewater having a low concentration of suspended solids. This invention incorporates a two-stage gravity system for cleaning and recovering BM that produces less waste by reducing its water content.

This invention has significant differences and improvements over Woodard as follows:

First, the approach described by this invention does not involve adding BM to an aeration basin so there is no increase in energy required to pump and to keep weighted biofloc in suspension, and no resulting operating or cleanout problems associated with BM settling to the bottom of the aeration basin.

Second, gravity clarification according to this invention uses a coarser BM (between 40 and 200 microns) that settles more rapidly in the secondary gravity clarifier and thereby increases its capacity further over the use of fine magnetite practiced by Woodard.

Third, since the approach described in this invention contains well-designed in-line mechanical and static mixers, flocculation is more efficient and better controlled to produce improved floc and therefore better water clarity.

Most importantly, Woodard describes “a system for enhancing an activated sludge process”. The process referred to by Woodard is commonly referred to as AST, which is the most common bacteria-based technology used to treat wastewater containing dissolved organics. AST is an aerobic technology that principally includes primary gravity clarification, followed by aerobic biological treatment, followed by secondary gravity clarification and sometimes tertiary treatment such as filtration, and followed by disinfection. See FIG. 1, discussed further below.

Woodard claims to enhance AST by using magnetite to increase the capacity of the AST secondary clarifier alone. There is no claim that their invention can be applied to the primary clarifier to reduce the biological load on the AST system. Woodard did not recognize that charge modification either by pH or by chemical modification of BM to clarify raw sewage in a primary clarifier would eliminate the possible need for chemical coagulants.

The normal performance of a primary gravity clarifier to remove TSS from raw sewage ranges from 40% to 60% because it is only capable of removing settleable solids and not fine or colloidal solids. Tests performed by this inventor showed that using BM and a flocculating polymer to treat sewage can remove over 90% of the solids because fine and colloidal solids are attached to the BM with the use of flocculating polymer and can settle out in a primary gravity clarifier or in a HSS that uses centripetal forces to enhance the gravity settling of solids. The use of BM in a primary clarifier reduces the biological treatment load on AST and eliminates the need for chemical coagulants.

Not only are carbon adsorbents effective in removing a wide range of pollutant types from water such as heavy metals, toxic organics, and nutrients, but they can be functionalized to target specific pollutants. The surface charge on carbon adsorbents plays an important role in the adsorption process. Many pollutants in water have a negative charge such as organics and fine sediments and colloids. Therefore, placing a permanent positive charge on the surface of BM, e.g., by crosslinking a chemical such as polydimethylsiloxane, will accomplish this same effect as acidic pH control. Heavy metals in solution have a positive surface charge so an adsorbent that has a negative surface charge is more effective in adsorbing heavy metals. Therefore, the surface charge of BHC, BM, MBM, HC, and BA can be modified to make them more efficient in removing target pollutants.

One difference between Woodard and this invention is that Woodard attempts to improve AST by improving the conditions for biological treatment and increasing the capacity of the secondary clarifier by using BM. By comparison, in one embodiment, this invention provides the ability to replace AST altogether by converting both the primary and secondary gravity clarifiers to use MBM clarification techniques, and replacing biological treatment with HC or BHC produced from solid organic wastes recovered from sewage. In some cases, particularly a retrofit of an existing AST system, the biological process does not need to be replaced, only augmented by the addition of HC or BHC to assist in the removal of non-biodegradable pollutants.

The present inventor's U.S. Pat. No. 7,686,960 describes a two-stage process for removing dissolved contaminants and suspended solids from water using magnetite. In a first tank, water is clarified using magnetic seed material and in a second tank, dissolved contaminants are adsorbed onto magnetic adsorbent material. In both cases, a magnetic separator is used to remove magnetite and adsorbent material for the recovery and reuse of these materials.

This invention differs from U.S. Pat. No. 7,686,960 in many significant ways. First, U.S. Pat. No. 7,686,690 teaches a two-stage process comprising a high-rate magnetic clarifier that uses permanent magnets in a magnetic separator followed by a magnetic adsorption process. It is a standalone system and not designed to retrofit into an existing WWTP and does not involve retrofitting existing gravity clarifiers or HSS with BM or MBM to increase their treatment capacities. By contrast, this present invention can be a three-stage system as shown in FIG. 2b that involves first retrofitting the primary gravity clarifier with BM or MBM to increase its treatment capacity using gravity instead of a magnetic collector. Second, biological treatment in the aeration basin is replaced with HC or BHC produced from waste organic solids removed from the retrofitted primary clarifier. Third, BM or MBM is added to the secondary clarifier to increase its hydraulic treatment capacity also using gravity instead of a magnetic collector. In addition, “process liquids” from the production of HC or BHC using HTC are used to grow PB that are used in the conveyance system to reduce odor, corrosion, and the buildup of FOG. PB can also be added to the treated effluent to increase the biological health of the receiving waterway. Also not contemplated in U.S. Pat. No. 7,686,960 is the elimination of a flocculation tank and its replacement with a novel two-stage BM or MBM recovery system that uses BM or MBM for in-line flocculation instead of in-tank flocculation. U.S. Pat. No. 7,686,960 also uses magnetic devices in the cleaning of BM while this patent uses gravity to separate BM.

AST has been the technology of choice for the treatment of sewage and has been in use for over 100 years to treat wastewater containing organic wastes. AST is effective in removing nitrogen and phosphorus from water to prevent eutrophication of waterways. However, AST has many serious economic and environmental flaws, including: (1) it produces large quantities of hazardous biosolids that present a disposal problem, (2) it emits large quantities of greenhouse gases that contribute to global warming, (3) it uses large amounts of electricity for aeration, (4) it requires pumping of Returned Activated Sludge that reduces the capacity of AST, (5) it is slow to treat water and therefore requires a large physical footprint, (6) it is complicated to operate and difficult to keep bacteria functioning at peak performance (7) it cannot remove non-biodegradable pollutants such as toxic organics (biocides, pesticides, PFAS, etc.) and heavy metals, (8) it is not efficient in cold climates, (9) it has a large carbon footprint, (10) it has high operating costs due to electrical consumption and solid waste disposal, (11) it produces odor, (12) AST systems are expensive to build and operate and take a long time to build, and (13) AST systems are active breeding grounds for superbugs.

As to the last point, AST as a breeding grounds for superbugs, a UK review in 2014 on Antimicrobial Resistance estimated that by 2050 antimicrobial-resistant bacteria (superbugs) will cause ten million human fatalities annually and over that time lead to a $100 trillion loss in GDP worldwide due to: (1) antibiotics overuse, (2) because WWTPs provide optimum conditions for the spread of antibiotic-resistant genes between bacteria, and (3) because conventional AST followed by disinfection does not adequately remove all superbugs. Compound this with the fact that many developing countries use raw sewage to grow food, and since microplastics in WWTP wastes seem to provide a perfect place for superbugs to grow and exchange drug-resistant genes, it becomes imperative that the use of bacteria to treat sanitary wastewater is replaced with BHC, combined with PB as needed, and that improved clarification is provided by the addition of MBM, for the ultimate replacement of AST.

This invention describes a process to improve biological treatments such as AST with the addition of BHC and/or BA, but more importantly with the ability to replace biological treatment and eliminate or reduce all of its shortcomings by using BHC and/or BA produced from sewage wastes to adsorb dissolved pollutants and increase the capacity of both the primary and secondary gravity clarifiers using MBM.

In summary, this invention provides a new process that (1) uses BM or MBM to increase the efficiency of clarifiers that use gravity in any form, (2) uses HTC to convert waste organics into HC or BHC or any carbon based adsorbent such as biochar or activated carbon to adsorb dissolved pollutants from wastewater, (3) uses HTC “process liquids” to grow PB, and (4) uses HDC and acid to: (1) improve HTC performance, (2) assist in the removal of heavy metals and the recovery of phosphorus from biosolids and other organic wastes, and (3) improves the adsorption performance of BHC. Therefore, this invention provides a replacement for biological treatment, in particular AST, because it: (1) treats water faster, better, and more economically, (2) uses less energy, (3) produces valuable byproducts from biosolids or solid organics removed by primary clarification that can be used to clean water, (4) produces no waste, (5) has a smaller carbon footprint, (6) removes non-biodegradable pollutants of concern, (7), operates efficiently in cold weather, (8) emits less greenhouse gas and odor, and (9) reduces the likelihood of superbug growth and gene transfer. However, improvement of existing AST systems according to the invention is also within the present invention.

The present invention also embodies an alternative to produce PB, BA, and BHC at selected industrial sites that produce large quantities of organic waste, such as food waste. Rather than require industry to pretreat their wastewater to remove suspended solids and perform biological treatment when necessary to be in compliance with their pretreatment permit, a preferred embodiment of this invention is for industry to only remove suspended organic solids, preferably with the aid of BM and to then use this weighted floc to produce PB and BHC or HC. The PB, BA and/or BHC/HC can then be discharged with their treated wastewater into the conveyance system. This approach provides the following benefits for industry and the WWTP: (1) the WWTP is already performing biological treatment so pre-biological treatment at an industrial site is counterproductive, (2) large scale biological treatment takes up valuable industrial space and operation of a biological treatment system is complicated and not well suited to many industrial operations, (3) solid waste generated at an industrial site is more likely to be disposed in a landfill, but by following this invention, these solid wastes become converted by the WWTP into valuable byproducts such as BHC, (4) less greenhouse gases are emitted and a smaller carbon footprint is provided, (5) PB, BA, and BHC discharged into the conveyance system reduces odor, corrosion, and buildup of FOG, and (6) spills from the conveyance system will be pretreated thus minimizing the impact on the environment.

HSS is commonly used to treat storm water and CSO/SSO because this technology is simple to operate, is low cost, uses no electricity, can treat large volumes of water, and has a small footprint. HSS relies on a swirling vortex action to produce centripetal forces that cause higher density solids to move to the center of the vortex and settle out of the flow of water by gravity. However, HSS is not good at removing fine solids that do not settle well by gravity and therefore only removes around 50% of TSS. Adding BM or MBM and flocculating polymer to HSS will greatly enhance its ability to remove solids from water to over 90%.

Pretreatment permits required for industrial dischargers limit the amount of pollutants allowed to be discharged to a WWTP. Pollutant levels are measured at the boundary of the industrial facility and usually include Biological Oxygen Demand (BOD), Total Suspended Solids (TSS), oil and grease, pH and sometimes heavy metals. Unless this business method is changed to allow industrial dischargers to discharge PB and BHC into the conveyance system, the benefits of this invention embodiment will be somewhat limited.

Carbon adsorbents are used to adsorb dissolved pollutants from wastewater and bacteria are used to biologically treat dissolved pollutants. Since bacteria can only treat pollutants that are biodegradable, carbon adsorbents have been added to AST to remove what bacteria cannot. Since carbon adsorbents are a suitable biocarrier for bacteria or in this case PB to attach to and produce biofilm, carbon adsorbents that are colonized with bacteria become a BA that works to remove all dissolved pollutants from wastewater. However, for the combination of PB and carbon adsorbents to work effectively as a combined product, its buoyancy has to be controlled to assure that it comes into contact with the pollutants contained in wastewater. This is accomplished according to an aspect of this invention with the addition of BM that has a high specific gravity and will promote easy recovery of BA by gravity. Therefore, this invention describes a new and novel process that employs BM, MBM, BHC, HC and BA either combined into one product or separately to treat wastewater.

The process for delivering BHC and PB produced from organic wastes through a pipeline installed inside a wastewater conveyance system is described in application 2021/0179467 along with other methods to convert conveyance systems into treatment systems such as controlling water flow through the conveyance system to increase treatment residence time.

An important difference of the present invention from application 2021/0179467 is the process of combining clarification augmented with BM with BHC to retrofit into an existing WWTP to either enhance its performance or to replace biological treatment, specifically AST, altogether. Also new and novel is the combination of PB with BHC to produce a BA and controlling its buoyancy by the ratio of BHC to PB to BM so that it can be applied more effectively, e.g., in a variety of river remediation applications. Also new and novel is the practice of adding MBM that acts like a chemical coagulant to a primary clarifier or to HSS and a more efficient two-stage MBM cleaning system that will greatly enhance the performance of gravity clarifiers and HSS to remove solids from wastewater.

Millions of tons of contaminated biosolids that contain heavy metals, toxic organics, pathogens, and excessive nutrients are produced each year, causing major disposal problems and a waste of natural resources. These biosolids are either land applied, incinerated, or landfilled, each option losing a valuable resource and producing high levels of greenhouse gases. The only sustainable solution to this problem is to convert these biosolids and other solid organic wastes into valuable byproducts. For this to be accomplished environmentally, heavy metals must be removed, toxic organics destroyed, pathogens destroyed, and excessive nutrients removed. This invention accomplishes all of these goals by the combination of different processes including but not limited to HDC, HTC, and acid treatment used separately or in combination.

Millions of people, mostly in developing countries, die each year from lack of access to suitable sanitary wastewater treatment and its impact on drinking water quality. The percentage of sewage receiving treatment in developing countries is estimated by the World Health Organization to be about 20%. Raw sewage is mostly either discharged into rivers that supply drinking water or is used to irrigate for food production. Developing countries do not have the expertise, financial resources, or infrastructure to change this scenario if they depend on using biological treatment systems, specifically AST, that have been designed to meet the needs of developed countries. The only way to materially change this situation in the short term is for developing countries to perform enhanced primary treatment of raw sewage using BM and flocculating polymer followed by disinfection according to this invention to produce nutrient-rich water that is free of pathogens and TSS, which can then be used for safe food production. This invention discloses a novel process for improving sanitation that will save lives, reuse fresh water supplies, and grow food.

For the purposes of this invention, the process that combines BM with HC is referred to as BHC and when colonized with PB is referred to as BA.

### OBJECTS AND SUMMARY OF THE INVENTION

Aside from the preferred embodiment or embodiments disclosed below, this invention is capable of other embodiments and of being practiced or being carried out in various ways. Thus, it is to be understood that this invention is not limited in its application to the details of construction and the arrangements of components set forth in the following description and illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

Certain distinct elements of the process represented by this invention are known individually in the art, such as: (1) using PB for in-line treatment of conveyance systems and reducing the biological load on WWTPs, (2) using BM to speed gravity settling in a secondary clarifier, (3) using HTC to produce HC, (4) producing BHC by addition of iron salts or magnetite, (5) recovering magnetite from floc by shearing and magnetic devices in a single-stage system, (6) known adsorption properties of HC and the activation thereof, (6) growing PB using biosolids and other organic wastes having been lysed and disinfected by methods including mechanical, thermal, electrical, sonic, and HDC, (7) delivery of PB and other adsorbents (MLSS, biomass, clay, water treatment residues, etc.) via a pipeline installed inside a conveyance system, (8) use of “process liquids” from HTC to grow PB, (9) addition of PB downstream of a WWTP to improve the biological health of receiving waters, (10) using static and mechanical mixing in-line to flocculate suspended solids with the aid of polymers, (11) use of lime to disinfect biosolids, and (12) modifying the surface charge on magnetite by chemical crosslinking or pH adjustment.

However, these known elements have neither been modified nor combined in the ways proposed according to this invention, specifically by: (1) processing weighted floc (solid organics, BM and flocculating polymers) from a primary clarifier to produce BHC used to remove dissolved contaminants from wastewater, (2) replacing AST by adding BM or MBM to both the primary and secondary clarifiers with or without the use of chemical coagulants and by replacing biological treatment in the aeration basin with BHC or BA produced from sewage carbon wastes and other solid carbon wastes, (3) adding BM or MBM and flocculating polymer to HSS or any clarifier that uses the circular motion of water to aid in clarification to remove fine solids that are not settleable, (4) recovering weighted floc from a gravity clarifier or a HSS by gravity alone without the use of pumps, (5) replacing AST and Chemically Enhanced Primary Treatment (CEPT) with clarification augmented with the use of BM to produce BHC using HDC and HTC to treat biosolids from a WWTP, (6) using HDC as pretreatment to HTC to reduce BHC particle size, which enhances the adsorbent capacity of BHC produced, and releases heavy metals and phosphorus from cell liquids so they can be precipitated and removed, (7) using acid and HDC to dissolve heavy metals and phosphorus for their removal and recovery from biosolids or organic solids removed by primary clarification using a two-stage precipitation process, (8) recovering and reusing BM from weighted floc in a two-stage in-line system to produce a concentrated organic slurry more suitable for HTC using gravity only, (9) regenerating BHC onsite using HDC, acid, and HTC, (8) using dry organic solids to increase the concentration of solids (>10%) for optimum HTC performance, (10) using in-line static and mechanical mixers to flocculate suspended solids with BM and polymer prior to a gravity clarifier or HSS, (11) using venturi eductors instead of pumps to inject cleaned and fresh BM into a wastewater conveyance system, (12) replacing Veolia's BioActiflo technology and Evoqua's Captivator technology by converting the wastewater conveyance system into a biological reaction and adsorption system to replace solids contact tanks and removing solids from the wastewater conveyance system with any clarification process that uses gravity that may also be assisted by the circular motion of water augmented with BM for the treatment of CSO and SSO and any other wastewater, (13) combining BHC and PB into BA and then modifying buoyancy of BA by the ratio of each individual component, and (14) using HDC to reduce the particle size of lime (micronize) to less than 50 microns used to disinfect organic wastes, specifically biosolids from water treatment.

It is therefore an object of this invention to combine these technologies in a novel, efficient, and sustainable way that adds BM to gravity clarifiers and HSS to enhance clarification to remove TSS and uses HTC to produce BHC to adsorb nutrients, non-biodegradable pollutants, heavy metals, toxic organics, and pathogens contained in water, all in order to serve as a replacement for AST and other biological treatment methods.

Furthermore, it is an object of this invention to grow a mixture of PB and other microorganisms and to produce BHC and other carbon adsorbents from solid carbon waste contained in sewage to remove dissolved contaminants and reduce odor, corrosion, and FOG buildup in wastewater conveyance systems.

Furthermore, it is an object of this invention to use waste organics from water treatment to grow PB that are more efficient at removing dissolved organics from wastewater than the bacteria presently used in AST.

Furthermore, it is an object of this invention to use solid organic wastes such as septage, grease trap waste, agricultural waste, and food waste to increase the HC to BM ratio in BHC.

Furthermore, it is an object of this invention to add relatively dry solid organic wastes to HTC to increase the solids concentration to above 10% dry weight solids, the optimum level for HTC, instead of using thermal drying.

Furthermore, it is an object of this invention to use either organic or inorganic acid as pretreatment to HDC to: (1) dissolve solid heavy metals and phosphorus for their subsequent recovery and reuse, (2) weaken and rupture cell membranes to release cell liquids that contain heavy metals and phosphorus, and (3) activate BHC to increase porosity and surface area to enhance adsorption of dissolved pollutants.

Furthermore, it is an object of this invention to use HDC to reduce the particle size of BHC, which will improve its adsorption properties and reduce the reaction time of HTC.

Furthermore, it is an object of this invention to use HDC to reduce the particle size of lime that is added to disinfect organic wastes, which will speed reaction time and reduce lime usage.

Furthermore, it is an object of this invention to eliminate the use of biological treatment (i.e., AST) to treat wastewater, which leaves more nutrients (phosphorus, potassium, and nitrogen) in the treated wastewater for irrigation to increase food production.

Furthermore, it is an object of this invention to remove BM weighted floc from any clarifier that uses gravity or HSS by gravity alone without the use of pumps to clean and recover BM for reuse to flocculate TSS solids within the conveyance system prior to the gravity clarifier or HSS by incorporating static and mechanical mixers in-line.

Furthermore, it is an object of this invention to use a two-stage BM or BHC cleaning system using gravity that first reduces transport water to increase waste solids concentration for HTC treatment, and second, recovers BM or BHC from sheared weighted floc for reuse.

Furthermore, it is an object of this invention to regenerate exhausted BHC using HTC onsite.

Furthermore, it is an object of this invention to use venturi inductors to reinject clean and fresh BM or BHC or BA separately or combined into water flowing through a conveyance system.

Furthermore, it is an object of this invention to sterilize organic wastes with HTC or micronized lime for safe reuse in agriculture applications.

Furthermore, it is an object of this invention to reduce the amount of or completely eliminate superbugs and their ability to transfer genes to other bacteria in AST.

Furthermore, it is an object of this invention to produce BA composed of BHC, PB, and

BM in varying ratios to affect their buoyancy to improve their performance in conveyance system, in rivers, and as a replacement for biological treatment in AST.

Furthermore, it is an object of this invention to add PB to treated WWTP effluent to reduce the regrowth of pathogens in field irrigation or in receiving waterways.

Furthermore, it is an object of this invention to reduce the carbon footprint and the emission of greenhouse gas emissions from the treatment of wastewater by replacing AST.

Furthermore, it is an object of this invention to use micronized lime produced with HDC to increase the effectiveness of waste disinfection and reduce lime usage.

This invention embraces three principles. The first principle is to retrofit existing AST systems to recover valuable capital assets and delay the need for new construction. This is accomplished by retrofitting BM into primary and secondary gravity clarifiers to increase their treatment capacity and hence the capacity of AST. MBM or BHC addition will at least double the capacity of primary and secondary gravity clarifiers and remove a greater percentage of TSS. A typical gravity clarifier in a WWTP removes 40-60 percent of TSS. A ballasted clarifier using flocculating polymer and MBM or BHC removes over 90% of TSS. Tests performed by the inventor reduced TSS in raw sewage from 243 ppm to 9 ppm without the use of chemical coagulants, using only MBM and flocculating polymer.

Increasing the amount of solids that can be handled by the secondary gravity clarifier will also improve the biological treatment capacity of the AST aeration basin. Normally, MLSS concentration in the aeration basin is limited to 3000 to 4000 ppm due to problems with hindered settling in the secondary clarifier. When the limit of solids in the secondary clarifier can be increased due to improved settling of ballasted floc, MLSS concentration in the aeration basin can also be increased thereby increasing its biological treatment capacity. Therefore, retrofitting gravity clarifiers with MBM or BHC will increase the biological treatment capacity of AST and reduce sludge settling problems from small particle pin floc and filamentous bacteria that cause sludge bulking and reduced clarifier capacity.

Adding MBM to HSS or any clarification process that uses the swirling action of water to improve solids settling will have similar beneficial effects. HSS is effective in removing coarse settleable solids but is not effective in removing fine solids and colloids that do not settle by gravity. In storm water applications that contain a high percentage of fine solids and colloids, the effectiveness of HSS to remove TSS is only about 40-60%. Adding MBM and flocculating polymer will capture fine solid particles and increase their settleability. The advantage of HSS over gravity clarification is the Surface Overflow Rate (SOR). The average SOR for a gravity clarifier in a WWTP is about 0.5 to 1.0 gpm/ft². The SOR for a HSS that uses centripetal forces to increase the speed of solid separation ranges from 5.0 to 50 gpm/ft² depending on particle size and density. However, HSS is not much better than gravity clarification for small and light weight particles. Adding MBM particles that are at least about 50 microns in size and using flocculating polymer to attach fine particles to the MBM will increase floc size and density, which increases settleability. MBM is also more efficient in coagulating raw sewage to aid in flocculation.

The second principle is resource recovery. AST produces large amounts of waste biosolids that are difficult to dewater, which increases land application costs, and these biosolids contain hazardous heavy metals, toxic organics, and pathogens that may regrow further in the field. Also, AST treatment of organic wastewater converts dissolved carbon and nitrogen into carbon dioxide, methane, and nitrous oxides, all greenhouse gases that contribute to global warming. Rather than increasing solid waste pollution and adding to greenhouse gas emissions, it is more prudent to redirect carbon and other nutrients contained in sewage into beneficial byproducts such as BHC, BA, and liquid fertilizers that are free from pathogens and have reduced heavy metals and phosphorus. The treated water then has reduced heavy metals and contains valuable nutrients such as nitrogen and phosphorus and is therefore more suitable for growing food.

There are multiple uses for HC including: low-cost alternative solid fuels, soil amendments, chemicals and catalysts, building materials, and adsorbents to clean water and capture carbon dioxide from fuel combustion. As an alternative fuel, HC competes with low grade coal (lignite) and may be only worth about $50 per ton. As a soil amendment, HC competes with compost and may only be worth about the same $50 per ton. Both uses increase greenhouse gas emissions, while using HC as a water treatment adsorbent will not increase greenhouse gas emissions. Therefore, an important focus of this invention is the use of HC as an adsorbent to remove pollutants from water and to reduce greenhouse gas emissions.

If BHC is used to replace AST, greenhouse gas emissions are almost non-existent. In light of the focus on reducing greenhouse gas emissions, the clear choice is to convert solid carbon wastes, now usually either disposed of in landfills, incinerated, or land applied (all of which emit greenhouse gases), into BHC that can be used to eliminate AST treatment of sewage, which also emits large amounts of greenhouse gases. In addition, BHC as a replacement for Activated Carbon (AC) is worth $800- $1500 per ton.

As mentioned above, the major shortcomings of AST are: (1) high capital and operating cost, (2) large quantities of greenhouse gas emissions, (3) inability to remove non-biodegradable pollutants from water, (4) production of large quantities of hazardous biosolids that are difficult to dewater, (5) difficult to operate, (6) cannot operate efficiently in cold weather, and (7) a significant source of superbugs. Therefore, it is apparent that AST has nearly reached its maximum level of development and is no longer sustainable economically, environmentally, or socially and must be replaced. Therefore, one goal of this invention is to increase the percentage of sewage treated sustainably around the world and increase the utilization of treated wastewater for irrigation by replacing AST and other biological treatment methods with primary clarification using MBM to improve gravity clarification followed by disinfection to destroy pathogens. Carbon removed by primary clarification can also be used to grow PB that is beneficial to prevent regrowth of pathogens in the field and to increase food production.

There are numerous examples around the world where primary clarification is practiced to remove TSS, BOD associated with TSS, and pathogens; this was the first technology practiced in developed countries and is still widely practiced. However, these first systems relied on gravity settling in large lagoons; as urbanization progressed, these systems became large and therefore were replaced with AST systems that were good at removing nitrogen and phosphorus to prevent waterway eutrophication and provided a reduced footprint over lagoons. Over time it became apparent that AST has significant problems as described herein and because of its high cost and operating requirements is not suitable for developing countries. Developing countries are only treating about 20% of their sanitary wastewater and are using untreated sewage to grow food. This is causing major health problems with disease and parasites. Therefore, for this situation to change, it is important to replace AST with effective primary treatment in a two-stage process using BM or MBM followed by disinfection, which will maintain the level of nutrients in the treated wastewater to make it beneficial for growing food safely. The solids produced from primary treatment are then disinfected with HDC and lime for use in fertilizing agriculture.

Over time, enhancements to primary treatment were accomplished by the addition of chemical coagulants. This is called Chemically Enhanced Primary Treatment (CEPT) and has been successfully practiced around the world. See Harleman et al, Appropriate Wastewater Treatment in Developing Countries: Experiences with CEPT. For example, Hong Kong treats over 75% of its sewage with CEPT. San Diego's Point Loma WWTP treats sewage with CEPT for discharge into the Pacific Ocean. However, while CEPT is effective in improving the quality of treated water and is a suitable solution for treating sewage in developing countries because of improved water clarity, reduced footprint, and improved sludge dewaterability, it has some notable disadvantages. CEPT is (1) costly because of the use of chemical coagulants based on iron and aluminum metals (although less costly than AST), (2) increases waste quantities, (3) requires the storage of hazardous chemicals, (4) makes the resulting water treatment sludge less desirable for reuse in agriculture applications, (5) removes phosphorus needed for plant growth, and (6) removes alkalinity needed for biological treatment.

Magnetite BM or MBM, according to this invention, are an improved replacement to eliminate CEPT's shortcomings. Specifically, magnetite BM and MBM: (1) eliminate the use of coagulants, which reduces operating costs, (2) eliminate the storage of hazardous chemical coagulants, for example ferric chloride, which is highly acidic, (3) produce less sludge that is more suitable for reuse because it does not contain large amounts of iron or aluminum, (4) maintain high levels of phosphorus and alkalinity for plant growth, and (5) reduce plant footprint due to faster processing time.

Magnetite BM and MBM augmented with probiotics (i.e. BA) followed by disinfection are best suited for solving sewage treatment problems in developing countries because this form of water treatment: (1) is approximately one third the cost of AST, (2) produces less greenhouse gases and smaller carbon footprint, (3) requires less electricity, (4) is easier to operate requiring less trained operators, (5) has a smaller footprint, (6) is easier to site, (7) is faster to install, (8) produces probiotics that improve plant growth and reduce regrowth of pathogens in waterways and in field irrigation, and (9) maintains high nutrient levels in the treated water for increased food production.

In summary, developing countries require water treatment systems that: (1) have low operating and capital cost, (2) are easy to operate, (3) have low energy requirements, and (4) provide treated water that is nutrient rich and safe to grow food. The embodiment of this invention that meets all of these needs is HSS that has been enhanced by the use of BM or MBM followed by disinfection.

In developed countries, more advanced biological treatment, e.g., AST, is practiced to remove nutrients from treated wastewater to prevent eutrophication of receiving waterways. However, treated wastewater from WWTP in developed countries still contains heavy metals, toxic organics that are not bio-degradable, and provides an environment conducive to gene transfer from superbugs to other bacteria. AST also produces large quantities of biosolids that also contain heavy metals, toxic organics, and pathogens causing disposal problems.

It is recognized by those of skill in the art that carbon adsorbents are a proven and effective way to remove dissolved pollutants from water and improve the quality of water discharged from WWTPs. However, carbon adsorbents, especially AC, are expensive and are usually shipped offsite to be regenerated at high cost. Powdered Activated Carbon (PAC) was originally used because of its large surface area but problems with regeneration and difficulty of removal from water caused PAC to be replaced with Granular Activated Carbon (GAC). This solved PAC removal and regeneration problems to a degree but GAC caused other problems such as: (1) reduced adsorption due to reduced surface area, (2) need for separate GAC filtration tanks, (3) potential for clogging and channeling problems in treatment tanks, (4) increased pressure drop, and (5) added cost of product.

This invention contemplates the use of all types of carbon adsorbents such as hydrochar, biochar and activated carbon to replace AST. However, a preferred embodiment is to use HTC to produce BHC. HTC has a thermal advantage over other pyrolysis technologies used to produce AC and biochar from wet organic wastes because HTC does not need initial drying and HTC is operated at a lower temperature.

A preferred form of HC is BHC because it is denser and settles more rapidly by gravity in a clarifier or in HSS. Therefore, a preferred method for treating sewage as a replacement for AST in developed countries is primary gravity clarification enhanced with MBM followed by adsorption with BHC, followed by secondary clarification enhanced with MBM, and then disinfection. The advantages of this approach over AST are: (1) removal of all organics (biodegradable and non-biodegradable) to low levels, (2) reduction of carcinogenic disinfection byproducts caused by chlorine disinfection interacting with residual dissolved organics to produce chloramines, (3) reduction of greenhouse gases, (4) reduction of hazardous biosolid wastes, (5) more rapid treatment to reduce physical footprint, (6) less electrical usage, (7) removal of heavy metals, (8) affordable retrofit option, (9) reduced construction time, (10) less siting problems, (11) less odor, (12) lower capital and operating cost, (13) simpler operation and fewer operating problems, (14) smaller carbon footprint, (15) better sludge dewaterability, and (16) reduction of superbugs and gene transfer.

In developing countries, the preferred embodiment of this invention is a more simplified version that includes HSS enhanced with BM addition followed by disinfection. This eliminates the disadvantages of biological treatment and produces water that contains nutrients that are beneficial for irrigation to increase food production.

Producing BHC that contains carbonized solids and MB in a HTC can be accomplished in many ways, such as adding natural MB or adding produced nano-sized MB. However, the most cost-effective way to produce BHC is to use BM floc that contains organic TSS, HC, BM, and flocculating polymer recovered from a primary clarifier or HSS that has been augmented with BM. This process provides the necessary BM and carbon waste from sewage necessary for HTC to use heat and pressure to produce BHC. The ratio of carbon to MBM can be easily adjusted by adding other sources of organic wastes like food wastes, agriculture waste, animal waste, grease trap wastes, or septage to achieve an optimum level of >10 wt. percent solids necessary for optimum HTC performance. The adsorptive properties of BHC are also affected by the type of solid organic waste added, operating temperatures and pressures in the HTC, and addition of other chemicals to activate BHC to improve surface chemistry and porosity.

In summary, according to one aspect of the present invention, TSS and dissolved contaminants are removed from wastewater with a novel process that replaces AST. The process involves the benefits of circular economics where solid carbon contaminants contained in wastewater are removed by gravity enhanced with MBM and the resulting floc is processed with HTC to produce BHC, which can be used for other water treatment applications such as drinking water.

More specifically, an optimized process for treating wastewater involves BHC produced from organic wastes and colonized with PB to produce BA that is introduced upstream into a wastewater conveyance system or into an adsorber tank with sufficient time and agitation for dissolved pollutants to adsorb onto the BA. The minimum residence time is one minute and but can be as long as 2 hours. The needed residence time to adsorb dissolved pollutants is far less than the amount of time it takes for wastewater to flow through its wastewater conveyance system so adding BA into the conveyance system a suitable distance upstream allows adequate time for pretreatment before wastewater arrives to the WWTP. Agitation can be controlled by mechanical mixers located in an adsorber tank or through natural turbulence or turbulence created by static mixers or mechanical mixers located within the conveyance system.

Wastewater that contains TSS, BHC, MLSS, PB, and/or BAs flows through a conveyance system where flocculating polymer causes a weighted floc to form in-line. This weighted floc is then removed by gravity in a gravity clarifier or HSS or any clarification device using MBM. The MBM is recovered from the floc for reuse. The wastes from the MBM cleaning process are then processed in HTC to produce more BHC.

HTC is operated at a temperature and pressure that converts the TSS, waste organics, and dissolved organics adsorbed onto BHC into new BHC to treat sewage and “process liquids” that contain nutrients such as nitrogen, phosphorus, and potassium, all vital for plant and bacteria growth, and which, according to an aspect of this invention, are used to grow PB.

The newly produced BHC that may or may not be colonized with PB to produce a BA is then used to adsorb dissolved contaminants, either in the wastewater conveyance system itself or in an adsorber, in either case allowing sufficient residence time and mixing to assure adsorption of contaminants onto the BA.

A major advantage of using BHC in place of bacteria is that BHC or HC can be modified to target specific contaminants such as Contaminants of Emerging Concern (CEC), which include toxic organics, pesticides, hormones, heavy metals, and pharmaceuticals, while bacteria used in AST are more singularly purposed and are best at removing BOD, phosphorus, and nitrogen and are not able to remove CEC or other non-biodegradable pollutants.

While this invention is effective in adsorbing dissolved contaminants and will improve operating conditions in a wastewater conveyance system such as reducing odor, adsorbing hydrogen sulfide that causes corrosion, and adsorbing FOG so it does not buildup on the wastewater conveyance system walls, biological treatment using PB grown on HTC “process liquids” or waste organic solids that have been lysed and disinfected with HDC and MLSS's ability to adsorb dissolved contaminants by contact are also effective elements of this invention.

HTC “process liquids” are high in nutrients that can grow PB, which can then be used to treat wastewater. Biological treatment using PB can be done in-line much the same way BHC is used to remove dissolved contaminants from wastewater and can also reduce odor, corrosion, and FOG in the wastewater conveyance system. HTC “process liquids” are completely sterilized by heat and pressure and heavy metals can be easily precipitated and removed so the “process liquids” are ideal for growing plants and bacteria.

The preferred mixture of PB used in the practice of this invention are non-pathogenic and non-toxic bacteria in the genus of Bacillus, which includes but is not limited to B. Subtilis, B. Subtilis var. amyloliquefaciens, B. Licheniformes, B. Indicus, B. Pumilus, B. Megaterium, B. Coagulans, B. Cereus, and B. Clausii, may also include bacteria from the genus of Pseudomonas, and may also contain enzymes. These bacteria are ubiquitous in nature, especially in soil, and are facultative by nature, meaning they do not need oxygen to survive and be productive. Therefore, they are effective in both aerobic and anaerobic environments to reduce odor and corrosion in a conveyance system by consuming chemicals, especially sulfur contained in wastewater. Other microorganisms can be combined with PB to enhance the treatment of wastewater as presented in this invention.

Bioaugmentation performed in the conveyance system can be accomplished by growing PB onsite at a WWTP and then transporting PB or other adsorbents upstream through a pipeline contained inside the conveyance system; alternatively, PB and other adsorbents can be produced at the source of pollution upstream along the conveyance system using HDC or HTC.

Once wastewater has been treated in its conveyance system, clarification is necessary to meet total suspended solids (TSS) limits (usually 30 ppm) and Biological Oxygen Demand (BOD) limits (usually 30 ppm) associated with dissolved organics and suspended solids. Since a large percentage of TSS and BOD are in the form of fine solids that do not settle well by gravity, the most effective method for removing these fine suspended solids is using MBM and flocculating polymer in gravity clarifiers or by HSS.

Comingling storm water and sanitary wastewater produces CSO, which presents a major environmental problem because in some locations when it rains, receiving WWTPs cannot treat the increased volume of polluted water. Therefore, raw sewage may bypass the WWTP and be discharged untreated directly into a waterway. Various methods to alleviate this problem have been proposed and practiced, such as the construction of containment structures, which have not been completely satisfactory because of odor, large size, and problems removing sediments. Clarification and disinfection alone, while helpful, has not been universally accepted by the EPA, which has consistently required some level of biological treatment to achieve an 85% BOD reduction.

One proposed solution to meet the 85% removal and biological treatment requirements imposed by the U.S. EPA is referred to in the art as Biologically Enhanced Primary Treatment (BEPT). BEPT involves the use of MLSS and its ability to adsorb dissolved organic pollutants from wastewater when placed in a solids contact tank.

There are two main commercial treatment systems that practice BEPT. One is the Evoqua “Captivator” system that involves a solids contact tank to adsorb dissolved pollutants followed by a DAF system that uses the buoyancy of air bubbles to remove suspended solids. Captivator is installed in series before the WWTP so it treats full water flow during dry and wet weather events. The advantage of this system is that it consistently reduces the biological treatment load on the WWTP, but must be sized to treat a higher flow rate during storm events and does nothing to reduce the hydraulic load on the WWTP. The other system is the Veolia “BioActiflo” system, which also involves a solids contact tank followed by Actiflo that uses sand ballast for suspended solids removal. BioActiflo is installed in a bypass to the WWTP so therefore it is smaller in size because it only treats the bypass flow; it does nothing to reduce the biological load on the WWTP but does reduce the hydraulic load on the WWTP. Neither of these systems do anything to reduce odor, corrosion, or buildup of FOG in the wastewater conveyance system and they also involve large capital expenditure and require additional space for large solid contact tanks and clarification systems. DAF systems have a large footprint and high electrical needs and Actiflo produces dilute waste (0.1-0.3 wt. % solids) that places an additional hydraulic load on the WWTP.

As an alternative to BEPT to treat excess storm water flows associated with CSO and SSO, this invention describes the option of using MLSS produced by AST to adsorb dissolved organics by solids contact much like the Captivator and BioActiflo technologies but in the conveyance system, not in a solids contact tank. Another option is to replace AST with BHC or BA, and to also use them in the conveyance system to adsorb dissolved organics and to meet the EPA removal and biological treatment requirements.

This invention describes the lowest cost option to: (1) reduce the biological treatment load on the WWTP, (2) reduce problems with odor, corrosion, and FOG buildup in the conveyance system, (3) meet TSS discharge limits, (4) reduce physical footprint, (5) reduce greenhouse gas emissions by elimination of AST, and (6) comply with the 85% BOD reduction requirement by the U.S. EPA using biological treatment. In addition, MBM can be retrofitted into the WWTP primary and secondary clarifiers to increase the treatment capacity of AST to provide secondary biological treatment needed to comply with EPA requirements and BHC can replace biological treatment in the AST aeration basin. Since biological treatment is being accomplished in the conveyance system, flow rates that cannot be handled by the biological capacity of the WWTP can be bypassed through HSS augmented with MBM without the need for additional biological treatment in a solids contact tank.

In summary, injecting BHC for adsorption, MLSS for adsorption and biological treatment, and BA upstream into the conveyance system for biological treatment and adsorption followed by clarification augmented with MBM complies with the EPA 85% removal and biological treatment rules and is a better alternative to existing BEPT systems to treat CSO and SSO. MBM can also be added to the WWTP clarifiers to increase their treatment capacity to process increased flows from storm events.

The bacteria found in sewage conveyance systems have a large component of bacteria that is mostly found in the human digestive tract such as E. coli, which are not the same bacteria listed above, which are more efficient at removing BOD and other organics from sewage. Therefore, the best bacteria to treat sewage in a conveyance system are PB having been cultivated on raw sewage that is collected at the WWTP and then reinjected back into the head of the conveyance system.

However, to optimize the growing conditions for PB, raw sewage must first be disinfected to remove pathogens that will compete with growing PB. This is best accomplished either by using HDC to lyse and disinfect MLSS biosolids or organic solids removed by primary clarification or by using “process liquids” from HTC. PB grown at the WWTP can be transported through a pipeline inserted into the wastewater conveyance system as far as possible upstream to increase the residence time for PB and other products such as MLSS, BA, BHC, and MBM to treat wastewater prior to reaching the WWTP.

Instead of delivering treatment products through a pipeline installed inside the conveyance system to convert it into a plug flow adsorber and biological reactor, as an alternative, treatment products including but not limited to PB, MLSS, BHC, or BA can be produced at an industrial site with an adequate supply of organic wastes such as food wastes located upstream from the WWTP and then injected either separately or combined into the conveyance system along with clarified industrial wastewater.

This invention describes a new business model for a WWTP to modify its existing pretreatment discharge limits and if necessary to offer financial incentives to industrial discharges operating under a pretreatment permit. Presently, regulatory pretreatment limits are placed usually on TSS, oil and grease, BOD, and in some cases heavy metals. The quality of industrial wastewater discharged is measured at the industry boundary and if limits are exceeded, fines can ensue. If the benefits of this invention are to be fully realized, pretreatment discharge limits will have to be modified to account for the beneficial effect that PB, MLSS, BHC, and/or BA delivered into the conveyance system will have on the quality of water that is actually received at the WWTP.

One goal of a wastewater treatment system is to minimize the cost of biosolid treatment at a WWTP. Both the Actiflo and Comag/Biomag system remove settled solids from a gravity clarifier using BM and then recover BM for reuse, but in this process, produce large volumes of dilute waste. Settled solids removed from a gravity clarifier or HSS contain large amounts of transport water. For example, the Actiflo clarifier produces dilute waste that only contains 0.1 to 0.3 wt. percent of solids and requires additional thickening to reduce the amount of waste generated. This present invention solves the problem of dilute wastes with a two-stage BM recovery system used in combination with a gravity clarifier or HSS augmented with BM or MBM. Waste removed from a ballast clarifier contains TSS, BM, flocculating polymer, and transport water. The first stage of recovering solids and BM involves the separation of BM floc from transport water using a gravity separator. BM floc discharged from a gravity clarifier or HSS first flows into a gravity concentrator to separate settled floc from transport water. Transport water is directed back into the conveyance system for treatment and the separated floc flows into a shear device that uses mechanical forces to break the floc and separate BM from the waste solids. BM being heavier than organic solids is separated by gravity. The heavy BM can be returned to the conveyance system through an eductor device (shown in FIG. 6) and with the addition of flocculating polymer forms a new BM floc in-line before it enters the second gravity clarifier or HSS. The lighter weight solids are further concentrated and converted into HC or with adequate levels of BM into BHC using HTC. This two-stage BM Recovery System shown in FIG. 5 produces one-fifth to one-tenth the amount of waste as Actiflo and Comag/Biomag respectively.

The last principle is reuse of water resources. The world is running out of fresh water due to climate change, overuse, wastage, and excessive pollution. Many waterways are fouled with pollution so the world has become more dependent on ground water in great quantities, especially for agriculture. Therefore, one intent of this invention is to clean water only to the level where nutrients such as nitrogen and phosphorus are maintained at levels beneficial for growing food; discharge of treated water into the ocean or underground disposal are less preferred options. Therefore, this invention embodies the concept that sewage or other wastewater containing organics or other non-biodegradable pollutants should not be treated biologically. Instead, in a four-stage treatment process according to this invention, first gravity augmented with BM is used to clarify wastewater. Solid carbon particles are removed and converted into BHC using HTC. The resulting BHC has high value and is beneficial for removing dissolved pollutants from water by adsorption. BHC is used in a second adsorption step and following adsorption, gravity in a third step is used with BM to clarify wastewater to remove BHC and any other TSS. A final and fourth stage is disinfection. In another alternative, “process liquids” from HTC are used to grow PB and are either used in the conveyance system to reduce odor, corrosion, and buildup of FOG, used to improve biological treatment at the WWTP, used in the effluent after disinfection to reduce regrowth of pathogens in waterways or in field irrigation to increase food production. In some cases, only a three-stage process is necessary because using BHC that has replaced biological treatment is not impacted by the amount of suspended solids contained in the wastewater. Therefore, when adequate separation of grit, grease and floatables is achieved in a first clarifying step, only a three-stage process involving an adsorber followed by clarification using BM in either a gravity clarifier or a HSS and then disinfection is needed.

For BA to be effective, it must come into contact with the pollutant it is designed to treat. This can be either at the bottom of the water column to treat contaminated sediment, or in the middle of the water column to treat the majority of the water, or at the top of the water column to treat floating pollution such as algae. Therefore, the ratio of BM, BHC or HC, and PB combined into one BA product is controlled to change the buoyancy of the finished product as needed.

BM has the highest specific gravity of greater than 2.0 and is the heaviest of the three components. The specific gravity of HC and PB are mostly close to or less than 1.0 (the specific gravity of water). Therefore, BM has the greatest weighting effect on buoyancy and a high concentration of BM makes it easy to recover BA by gravity and will cause BA to sink. This is beneficial if the goal is to treat contaminated sediment. Activated carbon has proven to be successful in treating contaminated sediment but because it is rather buoyant, it does not easily stay in place. Combining BM with HC to produce BA of sufficient weight will solve this problem.

In cases where a neutral buoyancy is desired to minimize settling and floating, the buoyancy of BA can be increased by increasing the porosity of HC, so that entrained air will counter-balance the weight of BM.

In cases where a product that floats is desirable, then BM can be completely eliminated from the product. A variety of BA exhibiting different buoyancies can be used to solve a number of water treatment problems at the same time. For example, algae is a major environmental problem and one of the most cost effective methods to treat this problem is biologically. Also, algae requires sunlight to survive. It has been proven that probiotics such as Bacillus subtilis can kill blue green algae (BGA) and carbon adsorbents can adsorb the cyanotoxins released by BGA. Therefore, a product that floats to restrict sunlight needed by algae, adsorbs cyanotoxins, and contains PB to kill BGA is the most cost-effective method to solve algae problems. This combination product can help to solve the massive BGA problems being experienced in, e.g., Lake Okeechobee in Florida.

In the 2017 UN World Water Development Report, Wastewater: the Untapped Resource, it was reported that “On average, high-income countries treat about 70% of the municipal and industrial wastewater they generate. That ratio drops to 38% in upper middle-income countries and to 28% in lower middle-income countries. In low-income countries, only 8% undergoes treatment of any kind. These estimates support the often-cited approximation that, globally, over 80% of all wastewater is discharged without treatment.”

There are many reasons for this low percentage of treatment but the prime factor is financial. Biological treatment of sewage, by developed country standards using AST, costs approximately $7-10/gal of treatment capacity, so for example, the upper limit cost for a one million gallon per day WWTP is approximately 10 million USD. Added problems limiting the use of biological treatment in developing countries are: (1) high operating costs, (2) lack of trained operators, and (3) lack of reliable electrical sources to meet the high electrical demand of a modern secondary treatment WWTP, make it understandable why only on average 20% of sewage is treated globally.

Therefore, to have a major impact on reducing the amount of untreated sewage discharged by developing countries, there needs to be a simple system that is low cost, easy to operate, produces low greenhouse gas emissions, can be constructed quickly, uses less electricity, and produces byproducts that increase food production. The only way to accomplish these goals is to discontinue biological treatment as in AST and to only practice primary treatment using gravity clarification augmented with BM followed by disinfection and to maximize the use of treated water and nutrients contained therein to grow food.

The most sustainable alternative for developing countries to treat sewage is a three-stage treatment process that uses two stages of HSS followed by disinfection as shown in FIG. 7. The first stage Primary HSS removes grease, grit, floatables and other filterable solids found in raw sewage. This leaves only settleable and non-settleable solids that are then removed in a Secondary HSS that has been augmented with MBM. Flocculating polymer is added to the second HSS to attach solids and colloids to MBM and thus form a weighted floc that is then removed by gravity. The weighted floc discharged from the Secondary HSS is removed and processed to recover and reuse the MBM, while the separated solids are further processed and disinfected to make them suitable for reuse in agriculture as a fertilizer, or in other beneficial applications. HDC and lime are used to disinfect and lyse the organic cells contained in the sludge making it suitable as a fertilizer.

The biggest advantage of this sustainable process for treating sewage in developed countries is lower capital and operating cost. The estimated capital cost for this system is one-third to one-fifth the cost of a secondary biological WWTP plant designed to developed countries standards. Other significant advantages are: (1) reduced greenhouse gas emissions, (2) conversion of waste solids into beneficial byproducts, (3) low electrical usage, (4) nutrient recovery for increased food production, (5) rapid installation, (6) small carbon footprint, and (7) simple operation.

### BRIEF DESCRIPTION OF THE DRAWINGS

Other objects, features and advantages will occur to those skilled in the art from the following description of a preferred embodiment and the accompanying drawings, in which:

FIG. 1 shows the State of the Art for AST.

FIG. 2a shows an overview of this invention in a primary treatment mode that uses BM to clarify wastewater and uses removed organic wastes to grow PB that are used either in-line to improve conveyance system operation or in the effluent to increase food production or to improve the biological health of a waterway.

FIG. 2b shows an overview of this invention in a secondary treatment mode that first uses BM in a primary clarifier, then an adsorber to remove dissolved pollutants, and finally a secondary clarifier to remove remaining solids. Solids removed by the primary and secondary clarifiers are treated in a Sludge Processing System to grow PB and produce BHC.

FIG. 3 shows the details of a Sludge Processing System that uses HDC and HTC to produce BHC and PB with heavy metals and phosphorus removed and recovered.

FIG. 4 shows the details of a PB Production System that uses treated liquids from HDC and “process liquids” from HTC to grow PB.

FIG. 5 shows the details of a BM Recovery System retrofit to an existing gravity clarifier or HSS to increase its treatment capacity and to clean and recover BM in a two-stage treatment system.

FIG. 6 shows the details of an Eductor System to entrain clarified transfer water and

BM into a flowing stream of wastewater.

FIG. 7 shows the details of a three-stage treatment system designed for treating sewage in developing countries.

FIG. 8 shows the details of a shear tube that mechanically separates BM from waste solids.

### DETAILED DESCRIPTION OF THE INVENTION

While this invention is susceptible of embodiment in many different forms, there is shown in the drawings and will herein be described in detail specific embodiments, with the understanding that the present disclosure of such embodiments is to be considered as an example of the principles of this invention, and is not intended to limit this invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the Invention.

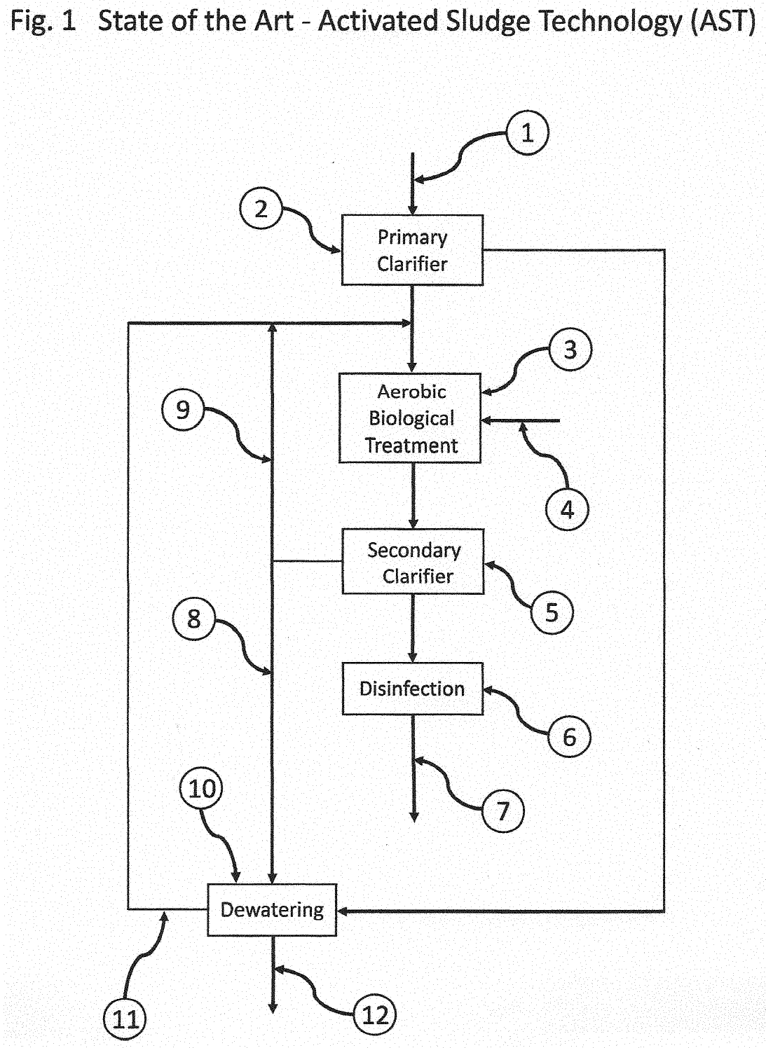

FIG. 1 shows the State of the Art for AST. Wastewater flows through a conveyance system (1) into a Primary Clarifier (2) that separates solids from water by gravity into a sludge slurry that flows to Dewatering (10). Clarified water from the Primary Clarifier (2) flows into Aerobic Biological Treatment (3) that uses bacteria and oxygen (4) to treat dissolved organic wastes. Treated water that contains MLSS flows from Aerobic Biological Treatment (3) into a Secondary Clarifier (5) that separates MLSS from clarified water. MLSS either flows (9) back to Aerobic Biological Treatment (3) as Returned Activated Sludge (RAS) or as Waste Activated Sludge (WAS) that flows (8) to Dewatering (10). In a retrofit embodiment of this invention, the effective performance of either or both clarifiers may be improved by employment of ballast material and flocculant, to improve settling of pollutants in the water stream.

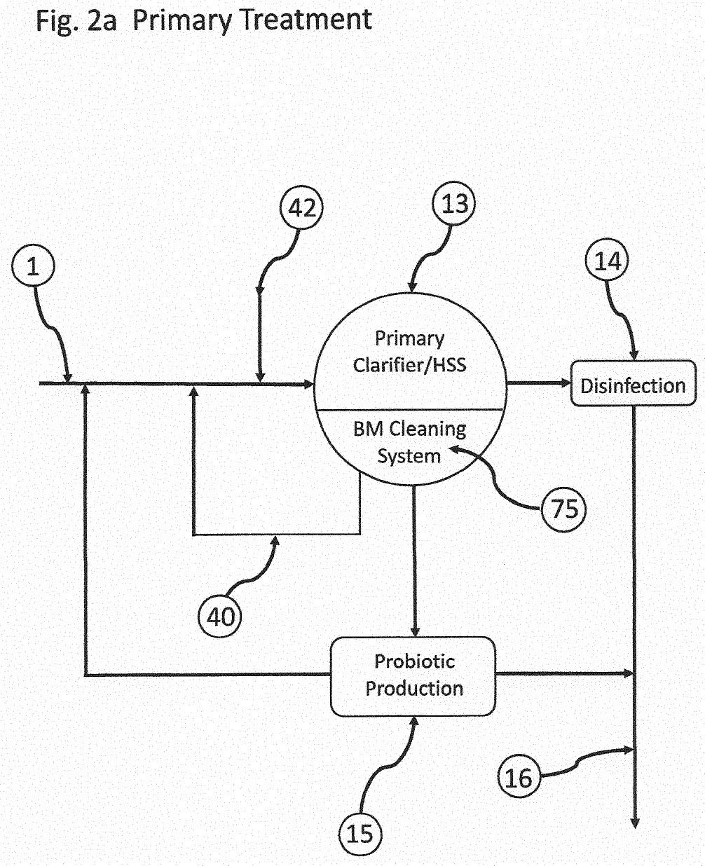

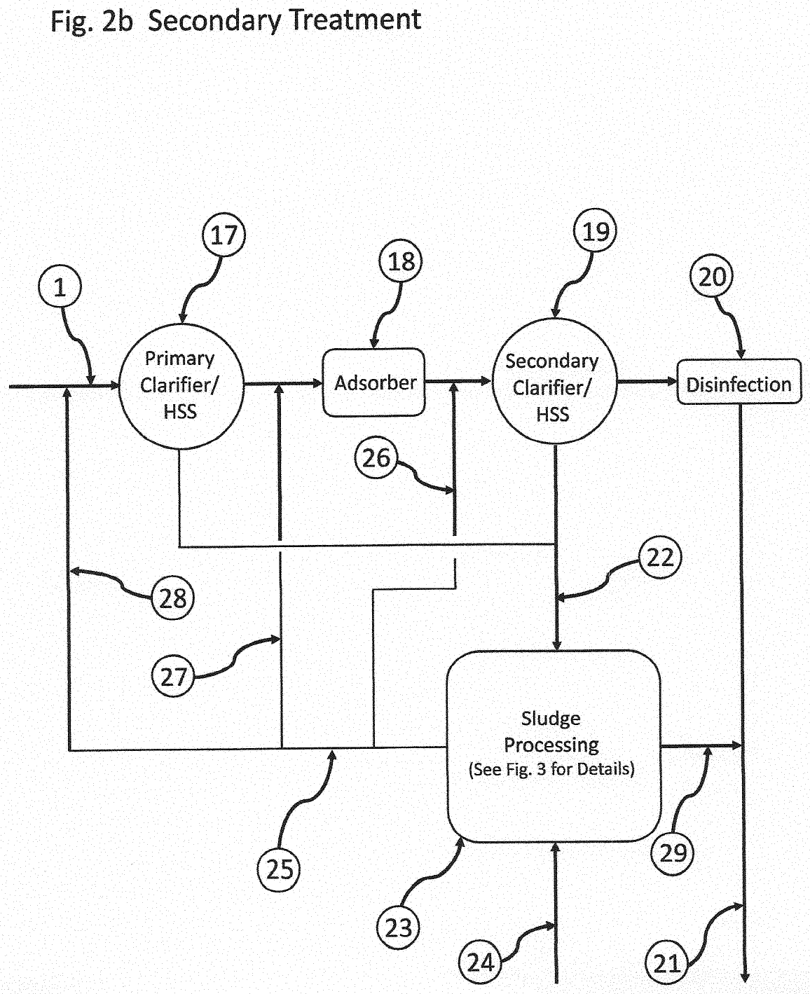

FIG. 2a shows an overview of this invention operating in a primary treatment mode. Wastewater flowing through a conveyance system (1) is combined with BM and flocculating polymer (42) before it enters into a Primary Clarifier/HSS (13) that removes TSS with the use of BM and flocculating polymer. The Primary Clarifier/HSS (13) separates BM, which after cleaning in the BM Cleaning System (75), is returned (40) to the wastewater conveyance system (1) to be reused to flocculate solids in-line before the Primary Clarifier/HSS (13). Separated solids from the BM Cleaning System (75) flows to Probiotic Production (15). Probiotic Production (15) disinfects solids and grows probiotics that are combined with treated effluent (16) after it has been disinfected (14).

FIG. 2b shows an overview of this invention operating in a secondary treatment mode that, rather than using biological treatment in an aeration basin as in AST, uses BHC to adsorb dissolved pollutants in an adsorber. Wastewater containing TSS, dissolved contaminants, BHC, and PB flows through a conveyance system (1) into a Primary Clarifier/HSS (17), which is either a gravity clarifier or a HSS that has been modified by the addition of BHC, MBM, or BM and flocculating polymer to increase its clarification capacity. Clarified water flows from the Primary Clarifier/HSS (17) into an Absorber (18) where it is combined with BHC and PB (27) received from Sludge Processing (23) to adsorb dissolved contaminants contained in the wastewater. Waste solids that are removed from the Primary Clarifier/HSS (17) flow as a slurry (22) to Sludge Processing (23) where organic solids are converted into BHC and PB (25). These flow separately or combined either upstream (28) into the conveyance system (1) to reduce odor, corrosion, and the buildup of FOG, or into the Adsorber (18) a device that contacts an adsorbent with an adsorbate with the purpose to remove dissolved pollutants, or into the Secondary Clarifier/HSS (19) or into the effluent (21) to improve the biological health of the receiving waterway or to irrigate for food production. Treated water from the Adsorber (18) containing BHC and PB then flows into the Secondary Clarifier/HSS (19) that removes suspended solids that flow (22) into Sludge Processing (23), and clarified water from the Secondary Clarifier/HSS (19) is Disinfected (20) before discharge (21). Supplemental sources of Organic Wastes (24) may be added to Sludge Processing (23) to increase the production of PB and BHC.

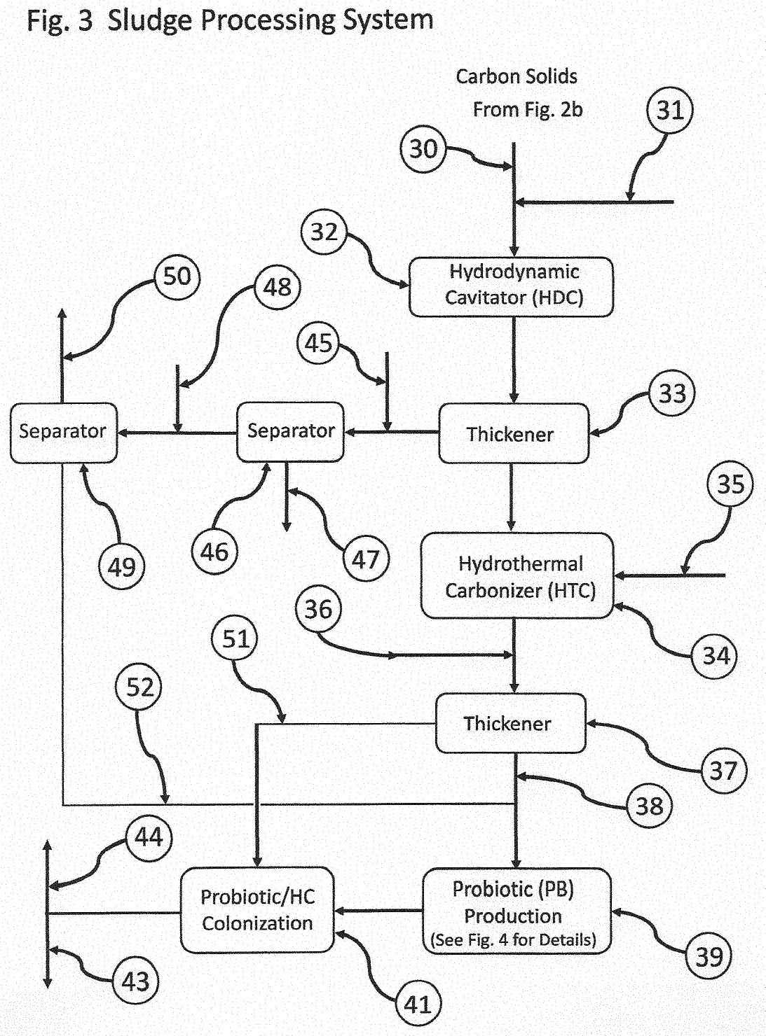

FIG. 3 shows the details of the Sludge Processing System that uses HDC (32) and HTC (34) to produce BHC and PB with heavy metals removed and phosphorus reduced. A slurry of carbon solids (30) flowing from Primary and Secondary Clarifiers/HSS combine with acid (31) to achieve a pH of less than 3.0 that is used to weaken cell membranes of toxic bacteria so they are more easily lysed in HDC, to dissolve heavy metals and phosphorus in biosolids (30) so they can be separated, and to pretreat biosolids to increase the porosity of BHC. The carbon solids (30) then flow into HDC (32) that uses collapsing microbubbles to break (lyse) organic cell membranes, releasing cell liquids containing heavy metals and phosphorus and reducing particle size to improve the treatment efficiency of HTC and increase the adsorption capacity of BHC. Liquids separated from Thickener (33) that separates solids from liquids by gravity or other mechanical means are treated in-line with a metal precipitant (45) and heavy metals (47) are removed with MHRC (46). Treated liquids from Separator (46) are then treated in-line with a phosphate precipitant (48) and phosphorus (50) is removed with Separator (49). Treated liquids that retain dissolved nutrients (52) then flow to Probiotic (PB) Production (39). Separated lysed solids from Thickener (33) then flow into HTC (34) where heat and pressure convert waste into BHC and “process liquids”. In addition, solid organic wastes such as food waste, agri-waste, and grease trap wastes (35) are also processed in HTC (34) and help to increase the solids concentration to a degree necessary for efficient HTC (34) operation (>10 wt. % solids). The pH of flow from HTC (34) is raised with caustic (36) to a range of 6-9 necessary to promote the growth of PB and then flows into a second Thickener (37) that splits the flow into BHC (51) that flows into Probiotic/HC Colonization (41) and “process liquids” (38) that flows to Probiotic (PB) Production (39). PB from Probiotic (PB) Production (39) flow into Probiotic/HC Colonization (41) to colonize with BHC (51) to form new BA. BA then can either flow (43) back into the conveyance system or flow (44) into an adsorber.

More specifically, HTC is a carbonization process that uses water, moderate temperature, and moderate pressure to increase the carbon levels in wet organic wastes. As shown in FIG. 3 (Sludge Processing System) wet organic solids are wastes from the primary and secondary MHRCs, are used to produce three carbon based products. The most prevalent material is a solid called HC, an effective carbon adsorbent, that is used in this invention to adsorb dissolved pollutants in an adsorber. Also produced (not shown in FIG. 3 for simplicity) are gases that contain hydrocarbons that can be either recycled back into the HTC process or used as a chemical feedstock. The final product is a “process liquid” that contains dissolved organics. It is this process liquid that is used to grow PB in this invention as also shown in FIG. 3.

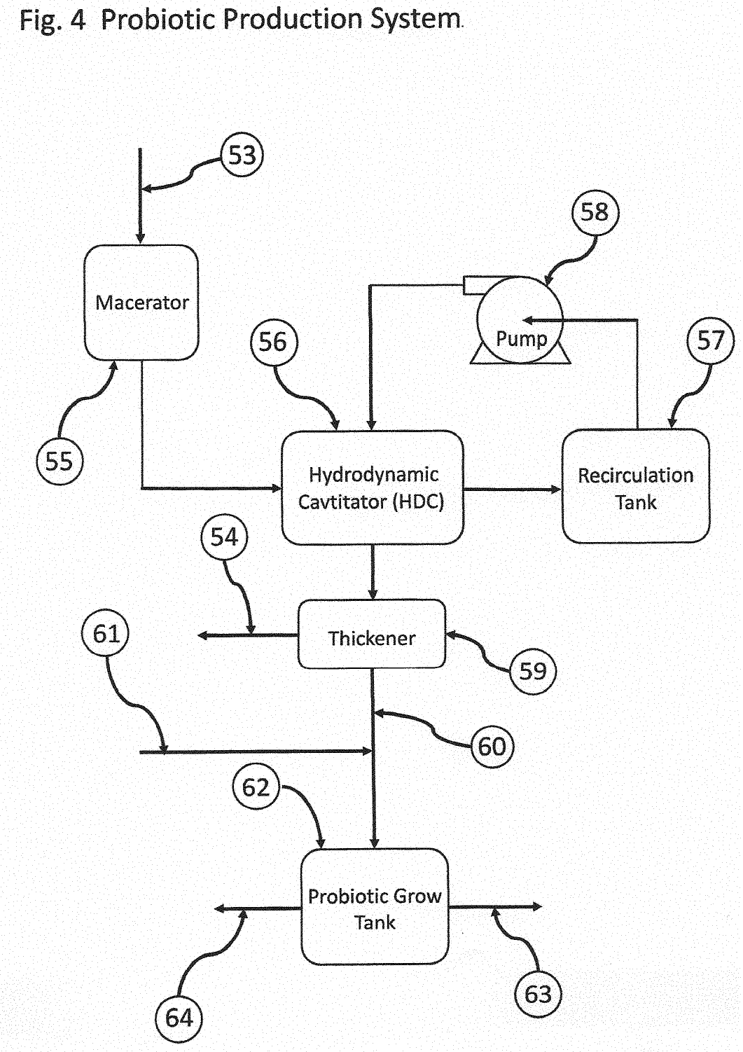

FIG. 4 shows the details of a Probiotic Production System that uses nutrients from dissolved organics and organic waste solids to grow PB. First, a slurry of organic wastes (53) flows into Macerator (55) that reduces the particle size of organic wastes (53) to produce a homogeneous feed slurry that flows to HDC (56) that further reduces organic waste particle size, disinfects pathogens contained in the macerated slurry to reduce competition with PB, and lyses cell membranes to release liquid nutrients beneficial for the growth of PB. The treated slurry from HDC (56) then flows into a Recirculation Tank (57) and is then pumped (58) back to HDC (56) for further processing. Treated slurry that has been lysed and disinfected by HDC then flows to a Thickener (59) that separates solids (54) that are processed into BHC or solid fertilizer and separated liquids (60) flow to Probiotic Grow Tank (62) along with “process liquids” from HTC (61). PB either flows (64) to the conveyance system (1) to reduce operating problems or is colonized on BHC or flows (63) into the effluent to improve the biological health of the receiving or is used to improve biological treatment at a WWTP.

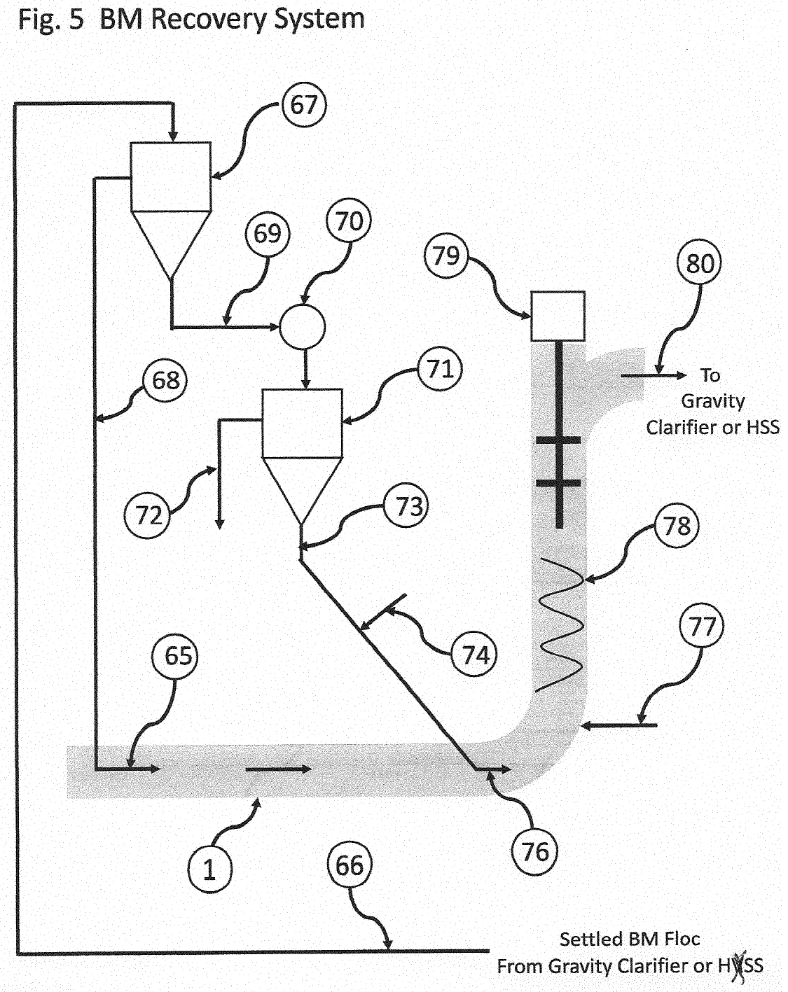

FIG. 5 shows the details of a system that recovers BM from an existing gravity clarifier or HSS that has been retrofitted to increase its treatment capacity by the addition of BM and flocculating polymer. BM floc settles in the gravity clarifier or HSS and discharges as a slurry (66) into the BM recovery system as shown in FIG. 5. The first stage of the BM recovery system is a gravity thickener (67) that receives BM floc (66) from a gravity clarifier or HSS and separates BM floc from transfer water (68). Transfer water, separated by the first gravity thickener (67), flows (68) back through an eductor (65) into the conveyance system (1). Settled floc (69) from the first gravity thickener (67) flows into a shear tube (70) that separates BM from carbon solids using mechanical shear force. The sheared slurry flows into a second gravity thickener (71), which separates solid carbon wastes (72) that is disposed of or reused to produce carbon adsorbents from cleaned BM (73). Cleaned BM (73) combines with new BM (74), and flows through an eductor (76) back into the conveyance system (1) where it combines with flocculating polymer (77). With the aid of a static mixer (78) and/or a mechanical mixer (79), BM floc (80) is formed, which flows into a gravity clarifier or HSS to enhance its performance.

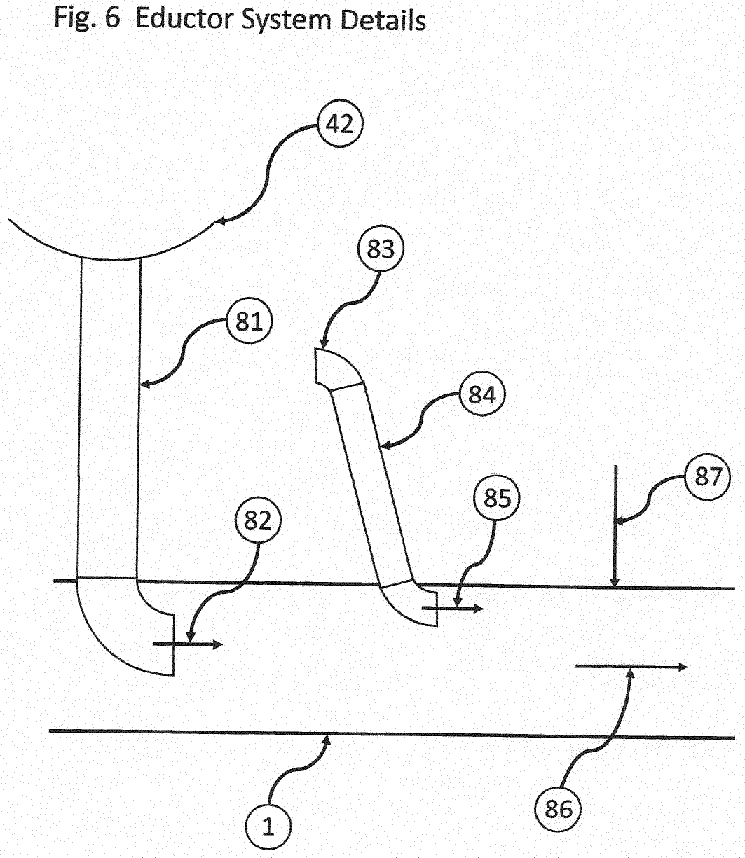

FIG. 6 shows the details of a first Eductor System (42) that entrains transfer water (81) through an Eductor (82) and into a conveyance system (1) in which a stream of wastewater (86) flows. A second Eductor System (83) entrains clean and fresh BM (84) into the same conveyance system (1) flowing a stream of wastewater (86). Both Eductors use venturi forces to draw transfer water (81) and BM (84) into the conveyance system (1) that contains a flowing stream of wastewater (86). Downstream, flocculating polymer (87) is added to form a BM floc that then flows into a gravity clarifier or HSS.

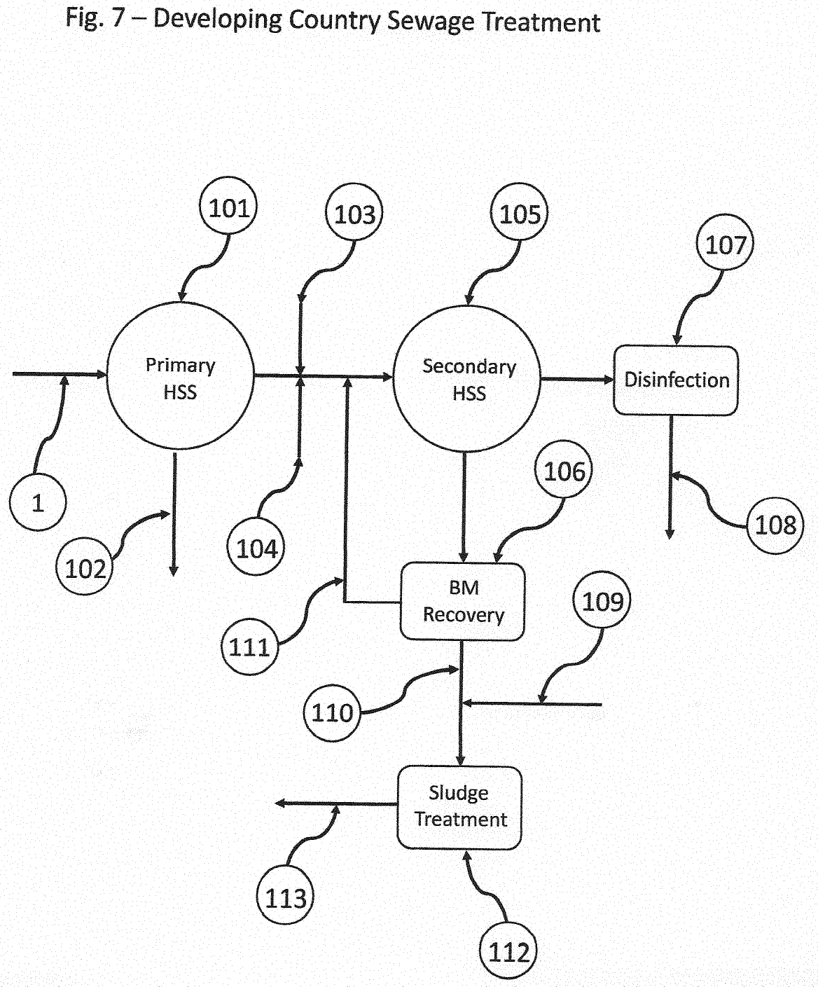

FIG. 7 shows the details of a process to treat sewage as a replacement for biological treatment best suited for developing countries. Raw sewage flows through a conveyance system (1) and into a Primary HSS (101) that separates floatables, grit, filterable solids, and grease that are discharged as waste (102). Treated sewage from the Primary HSS (101) flows into a Secondary HSS (105). Prior to entering the Secondary HSS (105), lime (103) is added for pH control and to act as a coagulant if necessary, recovered BM (111) is added as is flocculating polymer (104) to attach TSS to BM, and to form BM floc that then flows into the Secondary HSS (105). The BM floc enters the Secondary HSS (105) tangentially, causing the water and BM floc to move in a circular direction that forces the BM floc to concentrate in the center of the Secondary HSS (105) and settle by gravity to the bottom where it flows into a BM Recovery system (106). Mechanical forces in the BM Recovery system (106) cause BM (111) to separate from the waste sludge (110). BM (111) flows back into the Secondary HSS (105) for reuse, while waste sludge (110) is combined with lime (109) for disinfection and flows into Sludge Treatment (112) and after treatment exits (113) for reuse in agriculture. In Sludge Treatment (112), HDC is used to aid in the disinfection of the waste sludge and to micronize the lime to reduce its usage and increase its effectiveness as a disinfectant. Clarified wastewater exits the Secondary HSS (105) and flows to Disinfection (107) and is discharged (108).

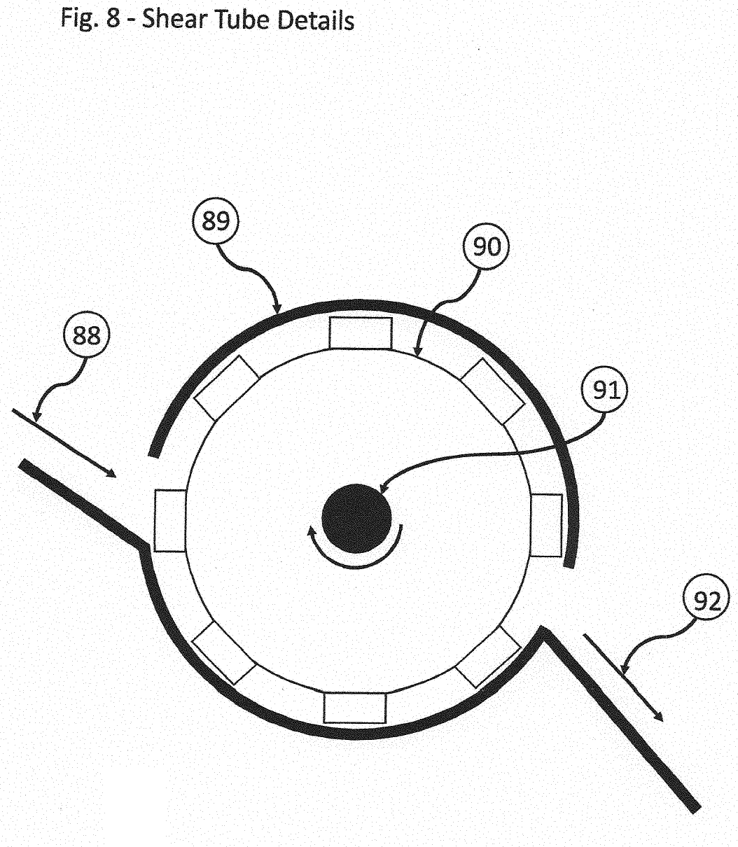

FIG. 8 shows the details of a device to clean BM or MBM so they can be recovered for reuse. BM floc (88) flows into a shear tube (89) with the purpose of disrupting the bond between BM and suspended solids caused by the presence of flocculating polymer. Inside the shear tube (89) is contained a plurality of shear blades (90) attached to a rotating shaft (91) that is moving at a fast pace, e.g., 1750 rpm. The sheared BM floc (92) then exits the shear tube (89) and flows into a gravity thickener that separates BM from waste solids by gravity.

What is claimed is:

1. A method for treatment of wastewater, comprising the steps of:
admitting the stream of wastewater to a primary clarifier;
allowing relatively course waste suspended solids to settle out by gravity;
removing the suspended organic waste solids from the primary clarifier and turning them into a carbon adsorbent that is used to remove dissolved pollutants from the water in an adsorber;
admitting the clarified water from the primary clarifier to an adsorber that contains the carbon adsorbent;
admitting the treated water from the adsorber to a secondary clarifier that has been modified by the addition of ballast material and flocculating polymer, such that a sludge comprising the ballast material, floc, and relatively fine particles settles to the bottom of the secondary clarifier;
removing the clarified wastewater from the secondary clarifier, and disinfecting it;
removing the sludge from the primary and secondary clarifiers; and
processing the sludge to separate the ballast material from the floc and fine particles and to produce carbon adsorbents.

2. The method of claim 1, wherein said step of adding ballast material and flocculating polymer to said stream of waste water is performed in-line before the secondary clarifier.

3. The method of claim 2, wherein static and in-line mixers are employed to improve the in-line flocculation process to form ballast material floc.

4. The method of claim 1, wherein the step of processing the sludge to separate the ballast material from the floc and fine particles shears the ballast material floc to separate ballast material from the flocculant and from other lighter weight solids so that cleaned ballast material can be reused in the in-line flocculation process.

5. The method of claim 4, wherein a sludge processing unit is employed to take organic solids from the ballast material recovery system and converts them into probiotics, ballasted hydrochar, or bio-absorbents.

6. The method of claim 5, wherein the sludge processing unit contains (1) acid addition prior to treatment by hydrodynamic cavitation to lyse cells to release heavy metals and phosphorus for later removal and to reduce the particle size to enhance hydrothermal carbonization performance by reducing reaction residence time and increasing surface area of ballasted hydrochar, (2) precipitation and recovery of heavy metals and phosphorus through chemical precipitation in a two stage process, (3) treatment with hydrothermal carbonization to convert carbon contained in the sludge into ballasted hydrochar, (4) a probiotic production system to grow probiotics using either lysed liquids from hydrodynamic cavitation or “process liquids” from hydrothermal carbonization, and (5) a colonization system to grow probiotics on ballasted hydrochar to produce bio-absorbents.

7. The method of claim 6, wherein said probiotics are selected from the genus Bacillus including B. Subtilis, B. Subtilis var. amyloliquefaciens, B. Licheniformes, B. Indicus, B. Pumilus, B. Megaterium, B. Coagulans, B. Cereus, and B. Clausii and from the genus Pseudomonas.

8. The method of claim 6, comprising the further step of promoting the colonization of probiotics on ballasted hydrochar, which acts as a biocarrier and then adding this bio-absorbent to a wastewater conveyance system to convert the conveyance system into an in-line treatment system.

9. The method of claim 6, wherein hydrodynamic cavitation is used post hydrothermal carbonization to (1) reduce the particle size of ballasted hydrochar particles to increase their adsorbent capacity, (2) reduce dissolved pollutant adsorption time, and (3) provide additional surface area for the colonization of probiotics.

10. The method of claim 6, wherein dry organic wastes are added to solid wastes produced by the ballast material recovery system to achieve a combined dry solids level greater than approximately 10% for optimum hydrodynamic carbonization performance.

11. The method of claim 6, wherein the surface of ballasted hydrochar is modified to make it hydrophilic by the addition of chemical treatment to promote the colonization of probiotics and to improve the adsorbency of colonized ballasted hydrochar.

12. The method of claim 6, wherein the ratio of ballasted hydrochar, ballast material, and probiotics contained in bio-absorbents is controlled to select their buoyancy and the buoyancy of ballasted hydrochar is modified by an activation process that increases the amount of void spaces contained in the ballasted hydrochar.

13. The method of claim 11, wherein the surface of the ballasted hydrochar is modified by chemical treatment that permanently modifies the surface charge so that it is better suited for adsorbing target pollutants.

14. The method of claim 5, wherein an education system is used to entrain recovered ballast material and fresh ballast material into a flowing stream of water without the use of pumps to transport ballast material floc from the second clarifier to the sludge processing unit.

15. The method of claim 1, wherein the clarifiers are configured as vortex separators.

16. The method of claim 1, wherein ballast floc removed from the primary and secondary clarifiers is transported using an inductor that transports the ballast floc to a ballast floc cleaning system.

17. The method of claim 1, wherein the ballast cleaning system contains two stages, the first stage separating water from floc by gravity, followed by a shear device that breaks the polymer bond between ballast from waste solids, followed by a second stage that separates ballast from waste solids by gravity.

18. The method of claim 1, wherein the ballast material has a specific gravity greater than 2.0, particle size between 40 and 200 microns, and includes but is not limited to sand, fly ash, magnetite, and zero valent iron.

19. The method of claim 1, wherein the flocculating polymer is either anionic, nonionic, or cationic, and preferably is a polyacrylamide flocculating polymer.

20. The method of claim 14, wherein the surface charge of BM and the adsorbent properties MBM can be modified and enhanced by methods such as but not limited to chemical, thermal, or crosslinked coatings such a polydimethylsiloxane.

21. The method of claim 5, wherein the probiotics produced from organic wastes recovered from the primary and secondary clarifiers is used to reduce odor, corrosion and the buildup of FOG in the conveyance system and is also added to improve the biological condition of the receiving waterway.

22. The method of claim 20, wherein the density of MBM can be increased or reduced to make it either float, be neutrally buoyant, or sink if discharged into a receiving waterway.

23. The method of claim 1, wherein BM and flocculant are also added prior to the first clarifier to assist removing fine solids.
